(19) United States
(12) Patent Application Publication
(10) Pub. No.: US 2007/0049460 A1
(43) Pub. Date: Mar. 1, 2007

(54) Method for kinetic (inertial) torque transmission and devices implementing it

(76) Inventor: Petre Nikolov Kolev, Marietta, GA (US)

Correspondence Address: Petre N. Kolev, 211 Greencrest court, Marietta, GA, 30068, US

(21) Appl. No.: 11/207,013

(22) Filed: Aug. 15, 2005

(51) Int. Cl. B60W 10/02; F16H 61/14

(52) U.S. Cl. 477/180; 477/169

(57) ABSTRACT

A method for transmission of rotational or linear energy and a device implementing that method in which inertia of a member that is a non liquid physical body put in motion repeatedly by a difference in the angular or linear speeds of an input shaft and an output shaft is the means for providing variable degree of engagement between said shafts where the number of changes in speed or speed and direction of said member and therefore said degree of engagement is proportional to the difference of linear, angular or linear and angular speeds of said input and output shafts. Since the degree of engagement greatly depends on the mass of the inertial member changing the mass of said member during operation can further expand the range of torque transmitted.

### CROSS REFERENCE TO RELATED APPLICATIONS

Not Applicable.

### FEDERALLY SPONSORED RESEARCH

Not Applicable.

### SEQUENCE LISTING OR PROGRAM

Not Applicable.

### BACKGROUND OF THE INVENTION

1. Field of Invention

This invention relates to a method for power transmission of torque from a power source, such as combustion engine to a load, such as the driving wheels of a car, truck, motorcycle or any other device that utilizes the use of torque.

2. Background of the Invention

Most mechanical transmissions function as rotary speed changers; the ratio of the output speed to the input speed may be constant (as in a gearbox) or variable. On variable-speed transmissions the speeds may be variable in discrete steps (as on an automobile or some machine-tool drives) or they may be continuously variable within a range. Step-variable transmissions, with some slip, usually employ either gears or chains and provide fixed speed ratios with no slip; step-less transmissions use belts, chains, or rolling-contact bodies.

Since no single kind of transmission satisfy the needs of all possible applications, each kind of transmission has more or less some specific use. So far, widely used in today's cars, trucks and tractor-trailers there are only two kinds of transmission—manual and automatic. Automatic transmission is easier to use, but is not efficient, because of the low efficiency of the torque converter. Significant part of the energy transmitted is spent for heating of the transmission fluid, which then has to go through radiator to cool down. A car with automatic transmission averages probably about 15% less mileage per gallon than a car with the same engine but with manual transmission.

Considering the fact that most people in America today drive unnecessary big and powerful SUV in the city just to go to work and back this 15% is considerable amount of fuel that pollutes the atmosphere of our country and our planet and decreases our petroleum reserves.

Manual transmission, although much more fuel efficient, is not the preferred choice due to several reasons. It has to be serviced several times for the life of the engine, it puts more peak load to the engine, and it is tiresome to use especially in traffic, which is the case most of the time in today's city. There are many people who would never consider driving a car with a manual transmission.

There is a widely used and inexpensive step-less drive called belt variator, which consists of a V-belt running on variable-diameter pulleys. Such drives however depend on friction and are subject to slip. They cannot transfer significant torque without being too heavy or too big. This is one of the main reasons why they have not found their place in today's car industry. Although largely used in small city motorcycles they lack the ability to deliver infinite speed ratio (necessary when the vehicle is not moving but the engine is not disengaged from the load) and have to be used with centrifugal clutch to address that issue.

In step-less transmissions employing rolling-contact bodies and known as traction drives, power is transmitted in a variety of ways that depend on the rolling friction of bodies in the form of cylinders, cones, balls, rollers or disks. Although quieter than gear transmissions, traction transmissions have serious drawbacks. They are very seldom used for mobile high torque applications and need sophisticated system of control in order to perform adequately. Use of special wear-resistant materials, which can withstand high contact pressure, is required.

### BACKGROUND OF INVENTION

### Objects and Advantages

(a) This invention is targeted toward solving the most significant drawbacks of the existing manual and automatic transmissions.

(b) Devices using this method will provide a behavior similar to that of an automatic transmission, while retaining the efficiency of manual one and in some regimes outperforming it.

(c) It is expected to be much simpler and cheaper to produce than an automatic transmission.

(d) Its life without servicing is expected to be as long or longer than that of an engine

(e) It can be used instead of differential transmission to independently deliver torque to each of the drive wheels in off-road machines.

(f) It is capable of indefinite change in the speed ratio.

(g) It is suitable for both small and big applications because of its simplicity and efficiency.

(h) It may be used in helicopters to increase fuel efficiency, because it would allow use of internal combustion engine without a heavy conventional transmission.

### SUMMARY

In accordance with the present invention a method uses the energy necessary for repeated change of the speed and/or direction of movement of a non-liquid physical body overcoming its inertia to provide a variable degree of engagement between a source of torque and a load. A device employing this method can be considered a clutch or a torque converter, although since its characteristics can be matched to engine's output characteristics it can replace a transmission entirely in some applications, especially in motorcycles where there is no need for a reverse shift and there is a greater difference between engine's idle RPM and RPM at normal driving speed.

### DRAWINGS—FIGURES

The following figures represent four of the many possible implementations of the method that is the subject of this patent application.

Drawing 1—Basic schema explaining the function of linear device

Drawing 2—Linear device—Parts and cross-sections

Drawing 3—Basic schema explaining the function of rotational device

Drawing 4—Rotational device—Parts and cross-sections

Drawing 5—Basic schema of combined linear-rotational device

Drawing 6—Linear-rotational device—Parts and cross-sections

Drawing 7—Basic schema explaining load dependent torque distribution

All implementations have corpus 1, input shaft 2, inertial member 3 and output shaft 4. These are the essential building parts and have the same corresponding numbers in all drawings from 1 thru 6. Some implementations involve use of links to facilitate the necessary freedoms of movement of the essential parts. The drawings are not an effort to represent an engineered device capable to withstand the forces resulting from their action. The drawings are rather simplified models to help in understanding the work of each particular implementation of the method that is the subject of this patent application. In the drawings, closely related parts have same number with different alphabetical suffixes.

Drawings 1 thru 6—reference numerals

1—corpus
1a—corpus
2—input shaft
3—inertial member
4—output shaft

Drawings 3 thru 6—reference numerals
5—link

Drawing 5 and 6—reference numerals
6—central link

Drawing 7—reference numerals
1—Main input shaft
1a—Secondary input shaft
2—Gear(s)
3—Corpus
4—Inertial transmission unit(s)
5—Wheels

### DETAILED DESCRIPTION

### Drawings 1

### Preferred Embodiment

Inertial Tourque Converter—Linear Implementation

This simplified linear device consists of four main elements as follows:

Corpus 1 and la comprise the main support element. The corpus 1 has a hole into which the cylindrical end of the output shaft 4 is inserted providing only rotational freedom for it.

Output shaft 4 also has a straight wedge, which is inserted into one of the two slots milled in the two flat surfaces of the inertial member 3. It provides the inertial member with freedom to only move along that wedge. Inertial member inherits rotational freedom from the output shaft. Inertial member 4 has a shape of a cylindrical disk with two slots, one on each of the flat sides milled at an angle related to each other that can vary in order to deliver different performance characteristics, but here for simplicity is 45°. This angle is one of the factors that determine the amount of displacement of the inertial member 4 during the cycle of operation. Other means for providing the same freedoms of movement of the corresponding elements can be used too and the effect will be similar. Important characteristic of the inertial member is its mass and how it is distributed. Heavier element will be able to transmit more energy provided all other variables remain the same. The axis of the hole in corpus la is coincident with the axis of the hole in corpus 1.

The input shaft wheel 2 is a swing arm, which base is inserted into a hole in the corpus la, providing it with only rotational freedom. Its eccentricity is the other factor determining the amount of displacement of the inertial member. The swing side of the swing arm is inserted in the front slot of the inertial member and can slide along this slot while rotating.

### Drawings 3-7

### Additional embodiments

### Detailed Description

### Drawings 3—4

### Inertial Torque Converter—Rotational Implementation

Part number one is the corpus with two holes having common axis. The output shaft 4 has a cylindrical flange with its axis parallel but eccentric to the axis of the shaft itself. The shaft is placed in one of the holes, which provides it with only rotational freedom. The flange is inserted into the hole of inertial member 3.

The inertial member is free to rotate around the axis of the flange and together with the flange around the axis of the holes in the corpus. It is connected to the input shaft 2 by a link 5, which transfers rotational movement from the input shaft to the inertial member despite the eccentric placement of the inertial member. Given fixed rotational speed on the input shaft this eccentric placement causes changes in rotational speed of inertial member during each cycle.

### Detailed Description

### Drawing 5—6

### Inertial Tourque Converter—Linear-Rotational Implementation

Corpus 1 and la comprise the main support element. The corpus 1 has a hole into which the output shaft 4 is inserted providing only rotational freedom for it.

The inertial member 3 here has a flat crest shaped form with four holes, one in each end. The shape is chosen for clarity—more important are the mass of the inertial member and the placement of the holes. The inertial member is attached to the load by two links 5, which act as swing arms and provide the inertial member with freedom of movement along a S-shaped trajectory (Trajectory Out on drawing 6) perpendicular to the axis of rotation of the output shaft. This trajectory represents the route of center of gravity of the inertial member related to the output shaft.

The input shaft 2 is a swing arm. The base of the input shaft is inserted into the hole in corpus 1 a and is provided with only rotational freedom. Its axis of rotation is coincident with the axis of rotation of the output shaft 4. The input shaft is attached to the inertial member by three links—two links 5 and central link 6.

The central link 6 has three holes. The swing arm of the input shaft is inserted into the central hole of the central link and can rotate in it. Two links 5 connect central link with the inertial member. The links that connect input shaft and inertial member provide inertial member with a freedom of movement along another S-shaped trajectory—perpendicular and crossing the axis of the central hole of the central link. The placement of the holes on the inertial member are chosen so that the two related freedoms of movement—input shaft to inertial member and inertial member to load are at an angle of about 45 degrees, similar to these on drawing 1. To illustrate an option of having inertial member with variable mass in this implementation a series of channels is shown through which a liquid can be fed into a cavity machined in the inertial member.

### Detailed Description

### Drawing 7

### Load Dependent Torque Distribution

FIG. 2 on drawing 7 shows an overall view of a simplified power train of a vehicle, which uses two inertial torque converters to independently deliver torque to each wheel.

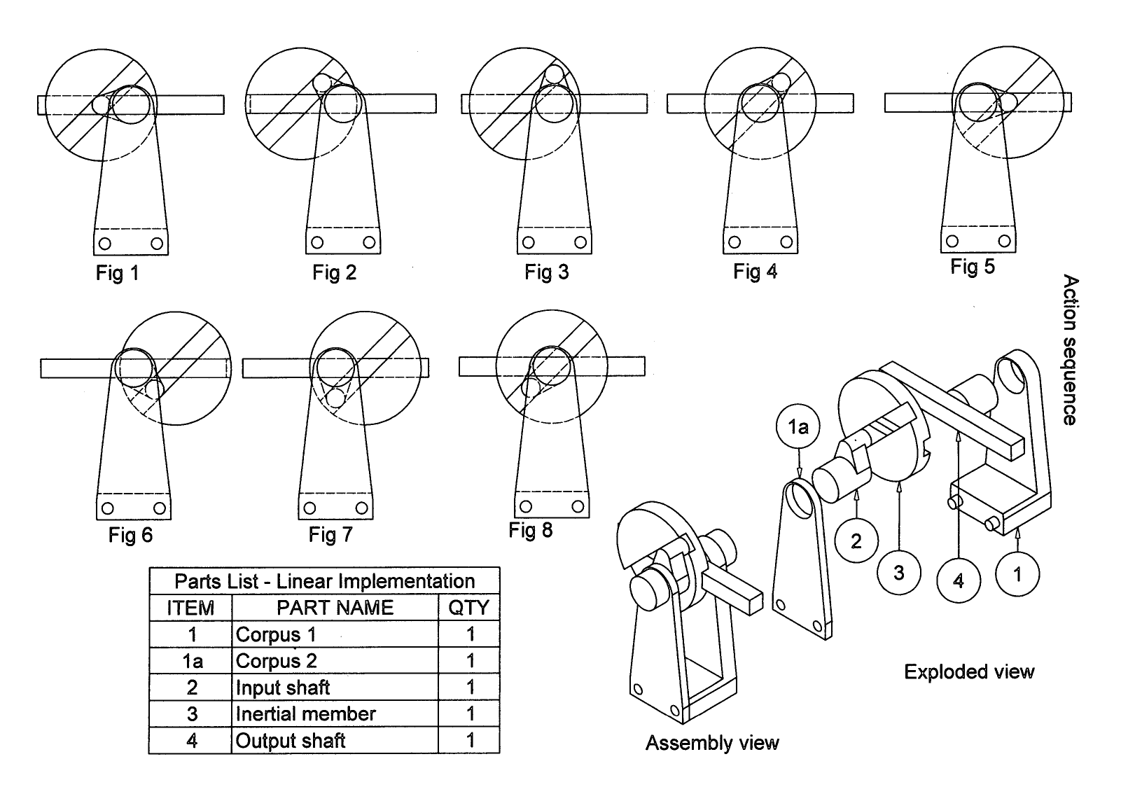

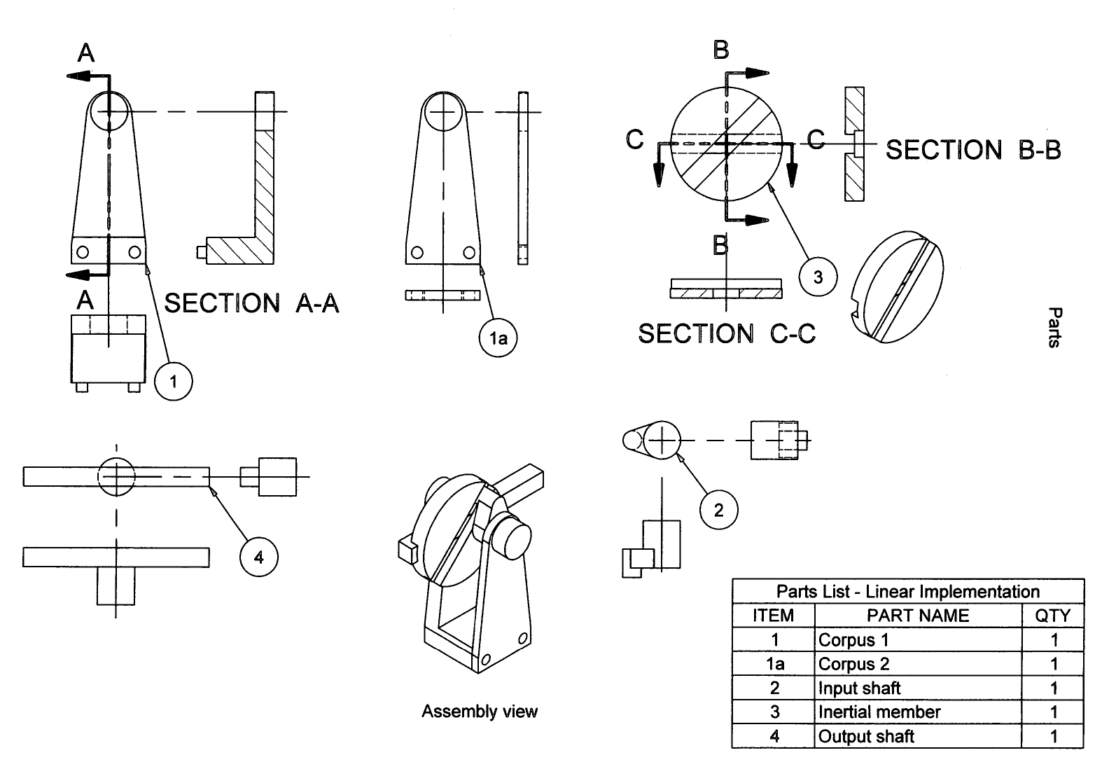

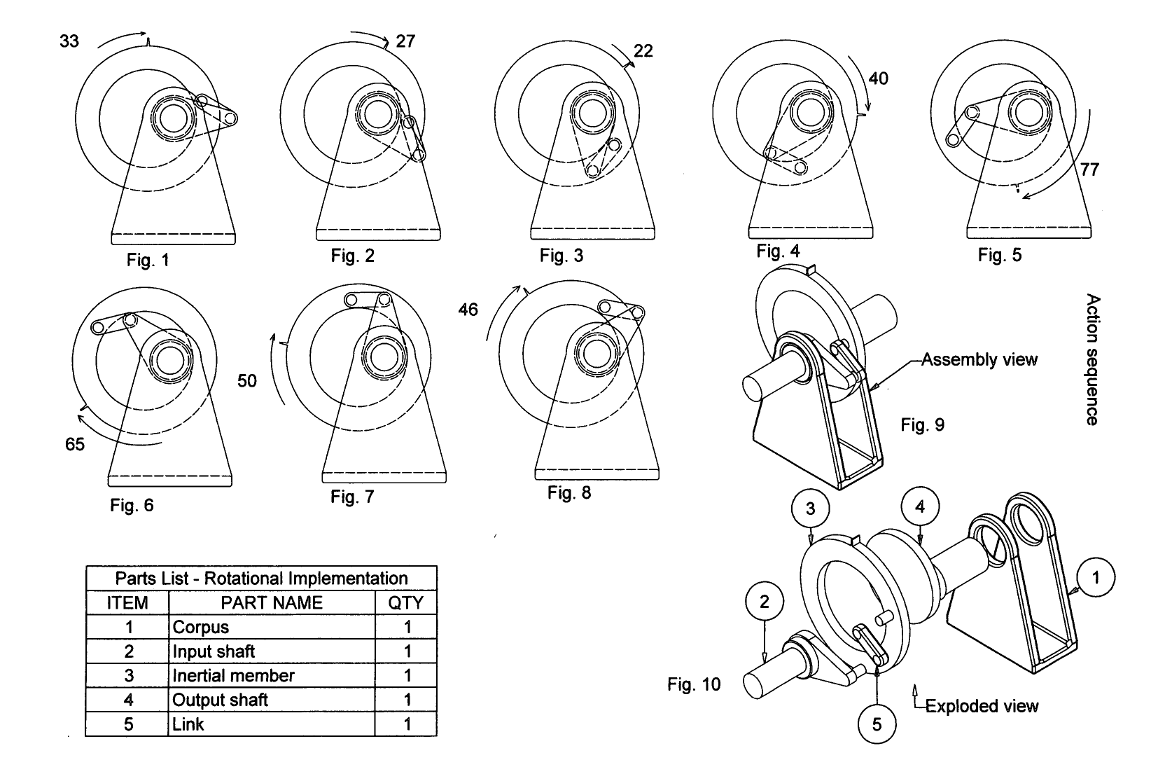

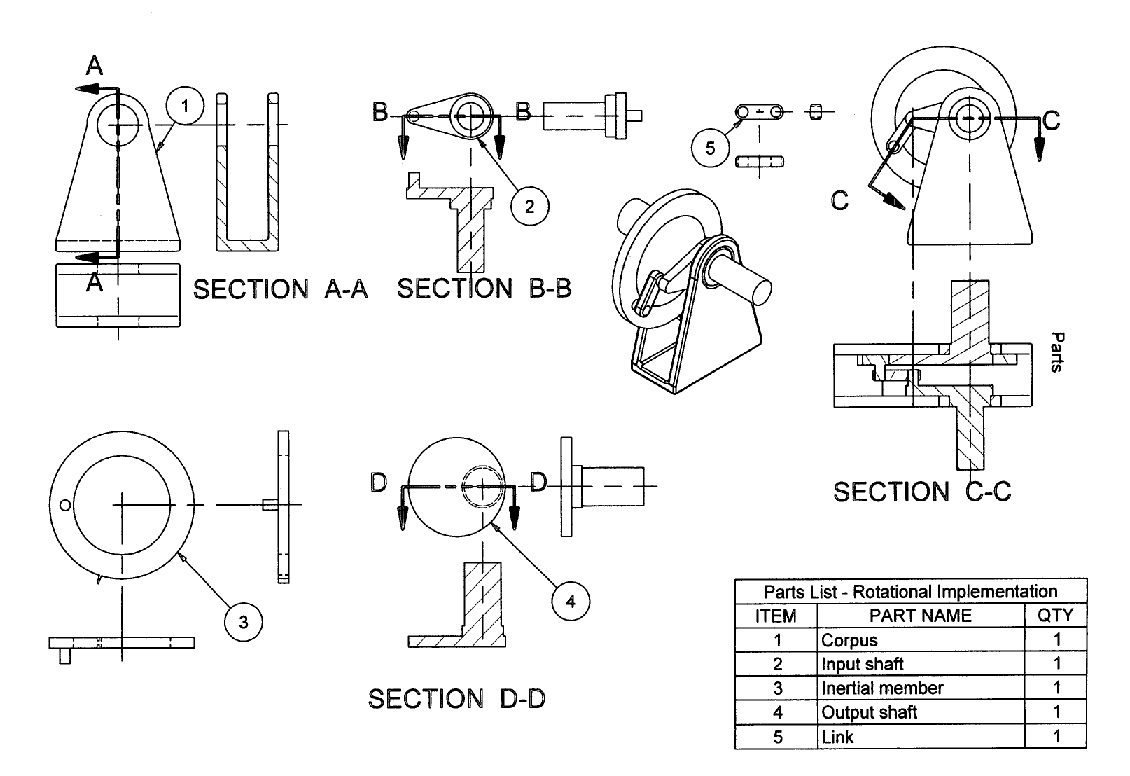

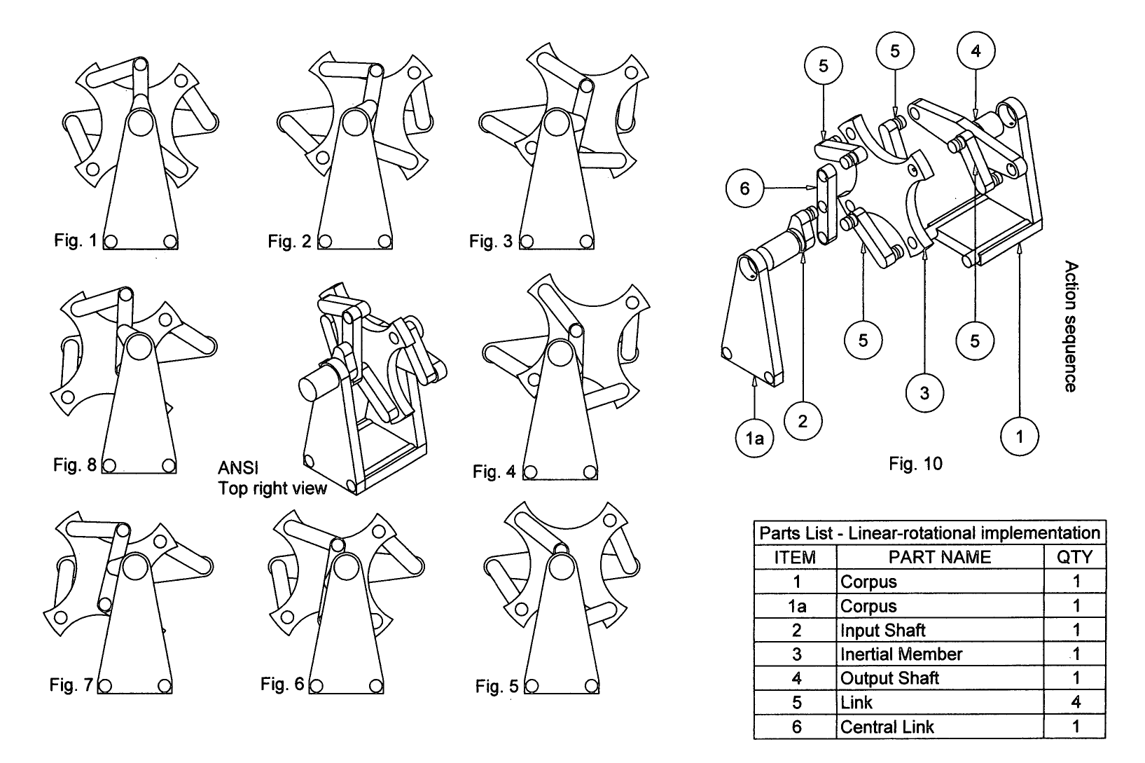

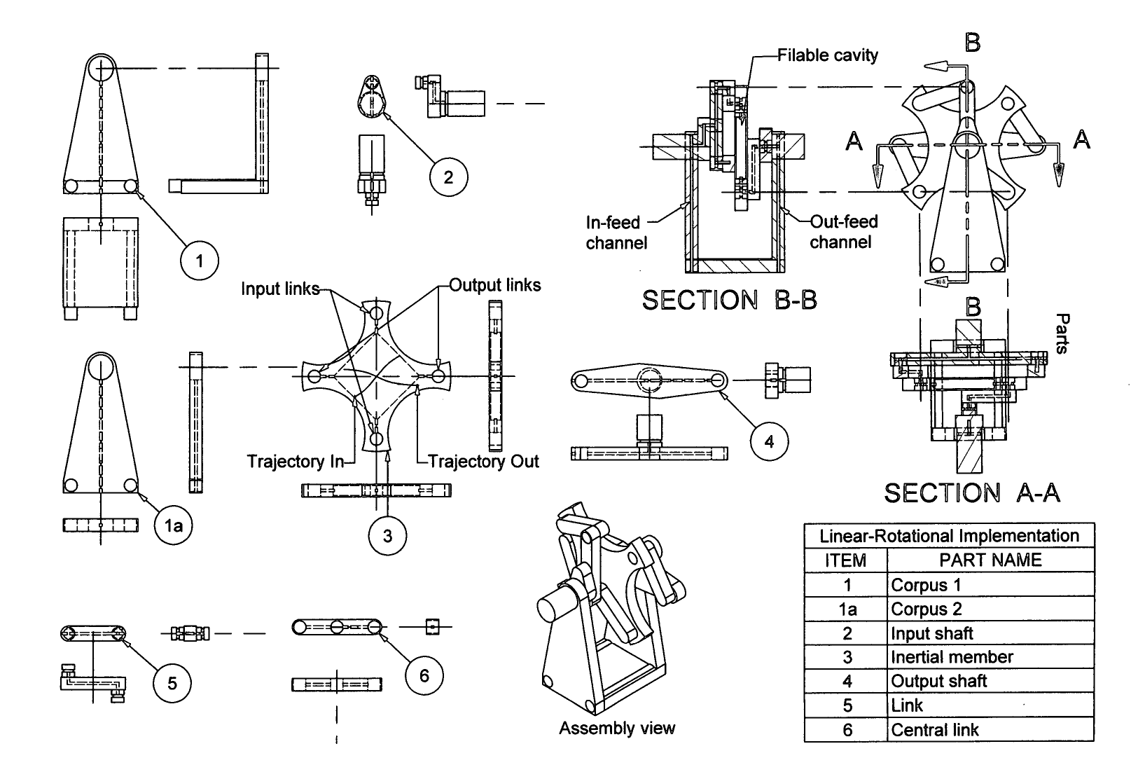

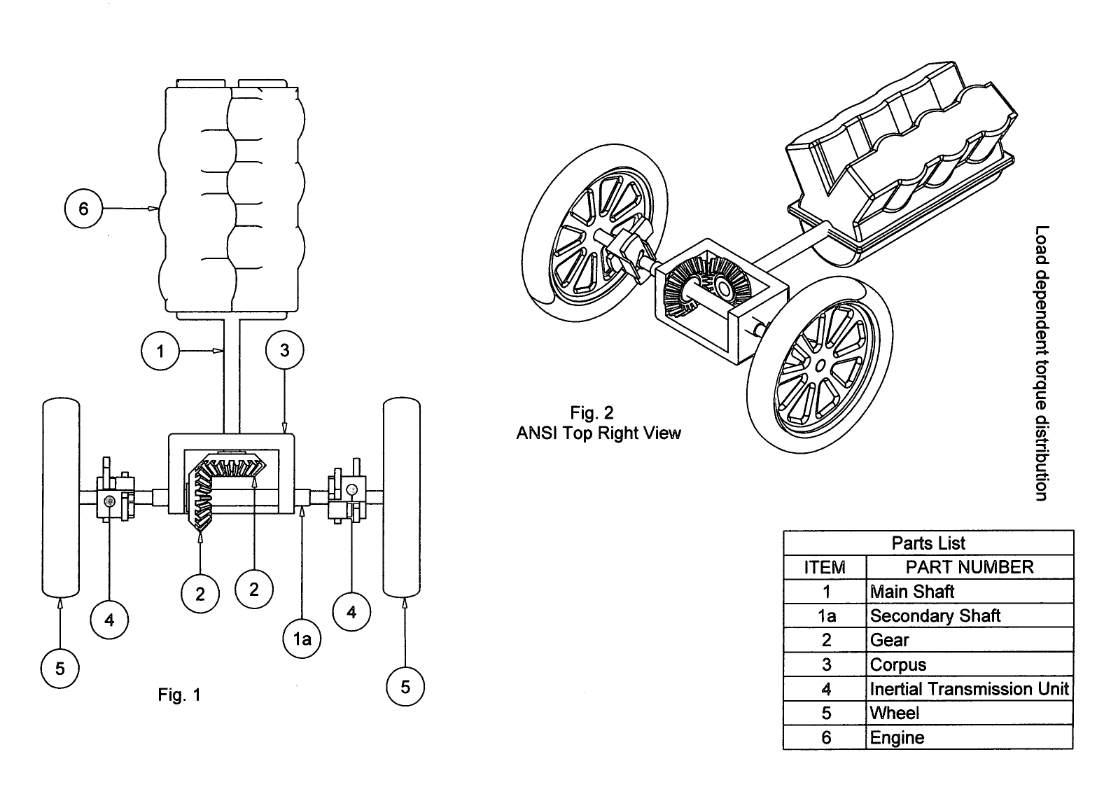

FIG. 1 on drawing 7 is top view of the same power train with all the main components numbered. Main shaft 1 delivers torque from engine 6 to secondary shaft la trough gears 2. Secondary shaft is input shaft for both inertial transmission units 4, which output shafts are engaged with wheels 5.

Operation—General

This method for transmission of power utilizes the ability of physical bodies with determined mass (called throughout this document inertial member) to accumulate and release kinetic energy when its speed (or speed and direction) of movement is changed. The input and output shafts of a device employing this method are engaged in a way so that if they have different speeds a member with certain mass is put in motion changing cyclically speed and direction and its inertia has to be overcome repeatedly. The force necessary to accomplish this is directed at some angle to the trajectory of freedom of movement of the inertial member but is applied in the direction of rotation of the output shaft. Thus the inertia of the inertial member creates a degree of engagement between the input and the output shaft. The difference between the speeds of the input shaft and the output shaft determines how many times the inertial member will have to change its speed and direction for a period of time. For each revolution difference between the speeds of the input shaft and the output shaft a predetermined number of changes in the speed and the direction of the inertial member are produced. This breaks the energy flow into small portions. The greater the difference between the speeds of input and output shafts, the more power is transmitted by each portion since the same mass has to change its speed in much shorter period of time and change in its speed is much greater. The sum of these portions, whose number also increases with increase in the speed difference, is summed to determine the degree of engagement between input and output shafts.

Combustion engine has by design very low output at idle speed and its power increases at higher RPM. The inertial transmission provides a low engagement degree between input and output shaft at low speeds and high engagement degree at high speeds. The amount of displacement of the inertial member(s) and its mass can be calculated so that at low engine RPM and low difference in speeds the transmitted moment is comparable but smaller than the output of the engine, while at the speed at which the engine achieves its maximum output the degree of engagement is great enough to transmit all the torque from the input to the output shaft.

Resulting torque is proportional to the difference between the speeds of input shaft and load. This kind of dependency makes possible this method for power transmission to be used to independently deliver torque to each of the drive wheels of an off road vehicle. Another important characteristic of the method is that the engagement exists in both directions and therefore the engine can be used as an aid for braking. Here is what would happen if the input shaft speed and the load are constant. When initially engaged the output shaft has a rotational speed of zero. If the moment created on the output shaft is greater than the countering moment of resistance then the output shaft will start to rotate. This increase in output speed will decrease the difference in speeds of input and output shafts and the moment created on the output shaft will decrease. This will continue until the two moments become equal. In case there is a constant speed on the input shaft and the load changes over time every increase in the load will decrease output speed and therefore increase the output torque. This process will continue until an equilibrium point is reached where the ratio between the input and output speeds is optimal. Decrease in the load will increase the output speed and decrease the output torque.

Drawings 1 Through 6

Figures one through eight shows devices in different stages of their operation, where the input shaft wheel on each figure is turned 45° clockwise compare to that on the previous figure. The drawings are not an effort to represent engineered devices capable to withstand the forces resulting from their action, but rather simplified models to help in understanding the work of each particular implementation of the method that is the subject of this patent application.

### Operation—Linear Implementation

### Drawing Sheet 1

In this drawing figures one through eight are successive captures of different stages of action of a simplified linear device for implementing the inertial method for torque transmission. FIG. 9 shows isometric view of the assembled device and FIG. 10 is exploded view of the same device and the parts list. In each figure the input shaft wheel has turned 45° clockwise compared to the previous figure while the output shaft is rendered unmovable to represent infinite resistance. From FIG. 1 to FIG. 2 the input shaft has turned 45°, but there is not much change in speed of the inertial member, and so there is no moment transmitted to the load during that stage. From FIG. 2 to FIG. 3 the inertial member starts moving to the right. Since the force that causes that movement has to overcome the moment of the inertial member and is applied tangentially to its center of gravity it creates a clockwise turning moment in it. The load wheel provides the only freedom of rotation of the inertial member, and therefore, this turning moment is actually applied to the load wheel. The same is true for the next 45° turn of the input shaft. The force overcoming the inertia of the inertial member is applied at an angle to the travel route of the inertial member and has a tangential component applied to the output shaft. FIGS. 5 and 6 show a key change in device's operation. In the FIG. 5 the speed of the inertial member practically remains the same, so there is no moment applied to the load. During that octet of the cycle the end of the swing arm has come in line with the wedge of the load wheel along which the inertial member can move. FIG. 6 show that the inertial member during this period of time has almost stopped its movement. The end of the swing arm applies its force from right to the left to overcome the inertia of the inertial member and slow it down, but this time under the line of the wedge, which again creates a clockwise moment. The action in the second half of the cycle is identical to the first half. This (linear) implementation of the method uses inertia of a member that moves in a linear fashion. In other words the center of gravity of inertial member changes its location related to the axis of rotation of the output shaft. Thus the degree of engagement of input and output shafts depends not only on the difference between their speeds but also on the speed of the output shaft. When the output shaft rotates the inertial member not only moves along the wedge of the output shaft but also rotates around output shaft's axis. This creates a centrifugal force in the inertial member and increases the force necessary to overcome its inertia therefore increasing the degree of engagement between input and output.

### Operation—Rotational Implementation

### Drawing Sheet 3

In this drawing figures one through eight are successive captures of different stages of action of a simplified rotational device for implementing the inertial method for torque transmission. FIG. 9 shows isometric view of the assembled device and FIG. 10 is exploded view of the same device and the parts list. Explaining the work of the device requires comparing each two adjacent figures, which represent snapshots of its components where the input shaft wheel has turned 45 degrees from one figure to another and the load wheel is rendered unmovable representing infinite resistance. Here the constant speed on the input shaft causes the inertial member to increase and decrease its speed once for each turn of the input shaft. That change in speed creates turning moment in the output shaft thanks to the eccentric placement of inertial member related to the axis of rotation of the output shaft. While from FIG. 1 to figure two the input shaft wheel has turned 45°, the inertial member has turned only about 26° (This numbers are true only for the shown figure. The degree to which the inertial member will turn at each stage and the degree of engagement between input and output shaft depends on the size of each element, the eccentricity of the load shaft (output shaft) and the length of the link 5, but the behavior in general remains the same). From FIG. 2 to FIG. 3 the input shaft has turned another 45°, while inertial member has turned 25°. There is almost no change in speeds of inertial member in this ⅛ of a turn and therefore no moment is applied to the eccentric flange of the output shaft. Next 45° of turn of the input shaft wheel would cause the inertial member to turn about 40°, which is significant increase in speed. In order to achieve this in such a short period of time the source of energy must overcome the inertia of the inertial member. In that period of time moment direction of the force applied is clockwise, it crosses the direction of movement of the inertial member and has tangential component to the load wheel. From FIG. 4 to the FIG. 5 there is even greater change in speed. The force applied is still clockwise and tangential to the load wheel so at this stage the load wheel continues to experience turning moment in clockwise direction. In the next three stages the speed of the inertial member would decrease if the input shaft wheel would keep its constant speed. The resulting force will be tangential, but in counterclockwise direction therefore reducing the effect of the first four stages. However, depending on the eccentricity between the axis of rotation of the inertial member and the axis of rotation of the load wheel and also depending on the length of the link 5 a disbalance is introduced in the two halves of the cycle, which makes the overall clockwise part of the moment much greater than the counterclockwise part. Also in actuality, the source of power or the engine will not act as a brake during that second half of the cycle but without the load it will increase its speed, gaining moment for the next cycle. The device as shown here is not balanced but this can be easily achieved by introducing another set that is offset 180 degree from the first set so that its disbalance counteracts the disbalance of the first one. This implementation of the method (rotational) uses only rotational moment of inertia to achieve a degree of engagement between input and output shafts. The distance between inertial member and the axis of the output shaft remains constant during the operation of the device. Therefore the degree of engagement depends only on the difference between the speeds of the input and output shafts.

### Operation—Linear-Rotational Implementation

### Drawing 5

This implementation makes use of the two varieties of inertia—rotational and linear. The operation is almost identical to that of the linear implementation, but thanks to use of swing arms the path along which the inertial member can move is not a straight line but a slightly “S” shaped and the inertial member not only moves along that line but also has some rotational component to its movement at the end of the trajectory. This makes the resulting torque applied to the output shaft less pulsating and smoothes the action of the mechanism. The shown implementation illustrates possibility for additional extension of range of output torque by changing the mass of the inertial member during operation. Trough a hole in the base of corpus la a liquid is pumped into channel in the input shaft and from there through a system of similar channels in the central link 6 and links 5 enters a cavity in inertial member. The air is driven out through similar system of channels in the other two links and the output shaft to a hole in corpus 1.

### Operation—Load Dependent Torque Distribution

### Drawing 7

The fact that this inertial method for power transmission creates higher degree of engagement when the difference between speeds of input and output shafts is greater and vice versa can successfully be used in all wheel drive vehicles. Without the need of complicated hydraulic or computer control it will behave the way an all wheel drive transmission should under most circumstances. If, for example, each wheel receives its momentum using that method independently from the same shaft—the secondary shaft 1a, and one of the wheels 5 slips it will increase its rotational speed. The difference between the speeds of that wheel and the engine will become smaller than the difference between the speeds of the other wheels and the engine and therefore, the torque transmitted to the slipping wheel by the inertial transmission unit 4 will be smaller than that to the other wheels. Since the difference between the speeds of the other wheels and the engine haven't changed the torque applied to the non slipping wheels will not change

### ADVANTAGES

To Manual Transmission:

No shifting. Change in speed is smooth. No clutch to be engaged or disengaged. No friction parts that need to be replaced several times during the life of the engine. No friction means no power is lost as heat and therefore it has better efficiency in heavy traffic. Its efficiency is better still because optimal engine speed can be maintained at all times during an acceleration, while with manual transmission after every shift the engine starts from low RPM goes thru optimal RPM and after reaching high RPM the next shift is engaged. That way the regime where the engine is most efficient is used only part of the time. A vehicle with inertial torque transmission—one using the method subject of this application is as easy to operate as automatic—the speed is controlled by the accelerator pedal only. The softer action of this transmission puts less peak load to the engine and helps prolong its life.

To Automatic Transmission:

It is simple to build and service. Requirements for the parts tolerances are not as high as for automatic and manual transmissions, their shape is not as complicated and their number is small. Automatic transmission is a very complicated mechanism with a great number of parts that are difficult to manufacture and therefore expensive. Automatic transmission's work depends on many other mechanisms and parts. It has statistically greater probability to fail compared to the less complicated mechanism of inertial torque transmission that does not depend on so many other mechanisms. Automatic transmission depends on the quality, quantity and temperature of transmission fluid, shift control and the computer, which on its part depends on engine speed sensor, throttle position sensor, overdrive switch, vehicle speed sensor and so on, and their work may still depend on other parts. Inertial transmission depends only on the input shaft speed and the output shaft speed—in other words on the difference between input and output speeds. Even the best automatic transmission has noticeable change in acceleration at some regimes when it shifts. (Even tough automatic transmission doesn't require driver's involvement it still shifts so that different sets of gears are engaged and has at least two clutches, not to mention the converter). Inertial transmission has no shifting and change in speed is smooth. Automatic transmission uses converter instead of clutch. It operates using fluid and friction in the fluid wastes some of the energy to heat and some means of cooling must be provided. Inertial transmission has no clutch and no friction other than that of ball or needle bearings. Another advantage of inertial over automatic transmission is that it has a better braking action, which is comparable to that of a MT.

### Conclusion, ramifications and scope

Inertial transmission incorporates the best quality of the manual and automatic transmissions, while getting rid of some of the drawbacks they have. It behaves as an automatic transmission in a sense that it changes its output torque and speed according to the ratio of the current input speed and the load. It has very soft action since there is no shifting—all the elements remain in their relative freedoms of movement at all times. It is simple—there are no gears to engage and disengage. Its work is based on its ability to carry all the energy from the source of power to the load. It has virtually no losses in power when in motion since there is no friction involved in its operation. Its use will decrease the air pollution and allow for longer use of the limited petroleum resources. It can be successfully used not only in cars and motorcycles but also in high throughput applications—busses, tractor-trailers and even locomotives.

I claim:

1. A method for transmission of energy comprising:
a. a repeated change in the speed or speed and direction of a non liquid physical body called here inertial member caused by relative difference in speeds of an input shaft and an output shaft and
b. coupling said input shaft, inertial member and output shaft so that the force necessary to repeatedly overcome inertia of said member is employed to provide a degree of engagement between said shafts.

2. The method from claim 1 where said repeated change is braking the contiguous torque on the input shaft of said transmission into a number of torque impulses where the magnitude and the number of those impulses constitutes the output torque and is proportional to the relative difference in the speeds of the input shaft and the output shaft.

3. The method from claim 1 where the mass of said inertial member could be changed during operation to further increase the range of output torque by filling a cavity in its non-liquid body with a liquid.

4. A method for a variable power transmission comprising:
a. coupling the input and output shafts of said transmission by means of a non liquid physical body called here inertial member where the direction of effort applied by the input shaft to the inertial member is crossing the trajectory of freedom of movement of said member at an angle displacing it cyclically, thus
b. generating a repeated change in the rotational, linear or combined moment of the inertial member, and
c. employing the moment necessary to generate said repeated moment change as output torque.

5. The method from claim 4 where the mass of said inertial member could be changed during operation to further increase the range of output torque by filling a cavity in its non-liquid body with a liquid.

6. A device for a power transmission called here inertial torque converter comprising:
a. a corpus providing housing for the rest of the building elements of said inertial torque converter and ensuring their relative freedoms of movement,
b. an input shaft that is either an output shaft of a power source or otherwise is connected to such a power source and delivers its effort to the torque converter,
c. an output shaft that is either a drive axle of a load or otherwise is connected to such a load and delivers the torque to said load,
d. an inertial member that is a non liquid physical body put in motion repeatedly by the difference in the angular or linear speeds of said input shaft and said output shaft which body can have a cavity that can be filled with a liquid therefore changing its mass, and
e. means for connecting input shaft to inertial member and inertial member to output shaft providing the necessary relative freedoms of movement of said shafts and inertial member
whereby said device will provide a variable degree of engagement between said power source and load proportional to the difference of speeds of said input and output shafts and in some implementations such as linear or linear-rotational additionally increasing with increase in speed of output shaft.

7. The device from claim 6 where the mass of said inertial member could be changed during operation to further increase the range of output torque by filling a cavity in its non-liquid body with a liquid.
